(19) United States
(12) Patent Application Publication
(10) Pub. No.: US 2007/0290451 A1
(43) Pub. Date: Dec. 20, 2007

(54) SEAL FOR ROTATING ASSEMBLY

(76) Inventor: Paul E. Yager, Nacogdoches, TX (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/764,309

(22) Filed: Jun. 18, 2007

Related U.S. Application Data
(60) Provisional application No. 60/804,980, filed on Jun. 16, 2006.

(51) Int. Cl. F16J 15/32

(52) U.S. Cl. 277/551

(57) ABSTRACT

A seal (10) for sealing the interface between a shaft (12) and a bore-defining wall (14) of a surrounding part (16). The seal (10) comprises a sleeve (20) for movement (or nonmovement) with the shaft (12), a case (30) for movement (or nonmovement) with the surrounding part (16), a bumper lip (40), a dirt lip (42), and a primary lip (44). A drain passage (60) continuously empties a potentially contaminant-accumulating chamber (50) between the bumper lip (40) and the dirt lip (42) thereby circumventing any contaminant ingress towards the primary lip (44).

### RELATED APPLICATION

This application claims priority under 35 U.S.C. §119 (e) to U.S. Provisional Patent Application No. 60/804,980, filed on Jun. 16, 2006. The entire disclosure of this provisional application is hereby incorporated by reference.

### GENERAL FIELD

A seal for sealing the annular interface between a shaft and the bore-defining wall of a surrounding part.

### BACKGROUND

A rotating assembly can comprise a shaft, a surrounding part having a wall defining a bore in which the shaft is positioned, and a seal sealing the annular interface between the shaft and the bore-defining wail. During operation of the assembly, the shaft and the surrounding part rotate relative to each other. For example, the shaft can rotate and the surrounding part can remain stationary; or the surrounding part can rotate and the shaft can remain stationary.

The seal can comprise a sleeve fixed to the shaft for movement (or nonmovement) therewith and a case fixed to the bore-defining wall of the surrounding part for movement (or nonmovement) therewith. The seal can have a dirt lip to discourage the ingress of contaminants (e.g., water, sand or other hard particles) from the air-side and a primary lip to prevent egress of lubricating fluid (e.g., oil, grease, etc.) from the fluid-side. A bumper lip, situated on the air-side of the dirt lip, will sometimes serve as a rough barricade for contaminants attempting to encroach the sealed interface. But many contaminants will sneak past the bumper lip. These wayward contaminants are then blocked by the dirt lip and accumulate in a chamber between it and the bumper lip.

### SUMMARY

A seal comprises a drain passage extending from a potentially contaminant-accumulating chamber to the air-side of the seal. Contaminants that would otherwise accumulate in this chamber are directed outward by centrifugal forces and will drop (via gravity) through the drain passage. Thus, contaminants (often sand and/or other hard particles) are continuously drained from the bumper-to-lip chamber without removal, repair, and/or replacement of the seal.

The drain passage reduces wear-and-tear on the seal itself whereby it decreases leakage and/or prolongs the seal's useful life. Such seal-specific improvements are, of course, always welcome. But more importantly, the removal of contaminants from the bumper-to-lip chamber prevents their eventual leakage by the dirt lip. Once contaminants seep past the dirt lip, they can become trapped in a chamber between it and the primary lip whereat the rotational wobble compacts them into a relatively hard mass. The contaminants caught and compacted in the lip-to-lip chamber can lift the primary lip off its sealing surface and this can cause devastating consequences. Specifically, for example, lubricating fluid will bleed from the seal, contaminants will invade bearing structures, and expensive equipment will be damaged or destroyed. By circumventing any contaminant ingress past the dirt lip, the drain passage can contribute to enormous cost and downtime savings.

### DRAWINGS

FIG. 1 is side view, partly in section, showing a seal sealing the annular interface between a shaft and the bore-defining wall of a surrounding part.

FIG. 2 is a sectional perspective view of the seal in a pre-assembled condition.

FIG. 3 is a side sectional perspective view of certain components of the seal, the components being titled to more clearly show a drain passage.

FIG. 4 is a sectional view showing a drain arrangement in a single-passage embodiment.

FIG. 5 is a sectional view showing a drain arrangement in a multi-passage embodiment.

FIGS. 6-7 are sectional views of modified versions of the seal in an assembled installed condition.

FIGS. 8-9 are sectional views of modified versions of the seal in an assembled pre-installed condition.

### DESCRIPTION

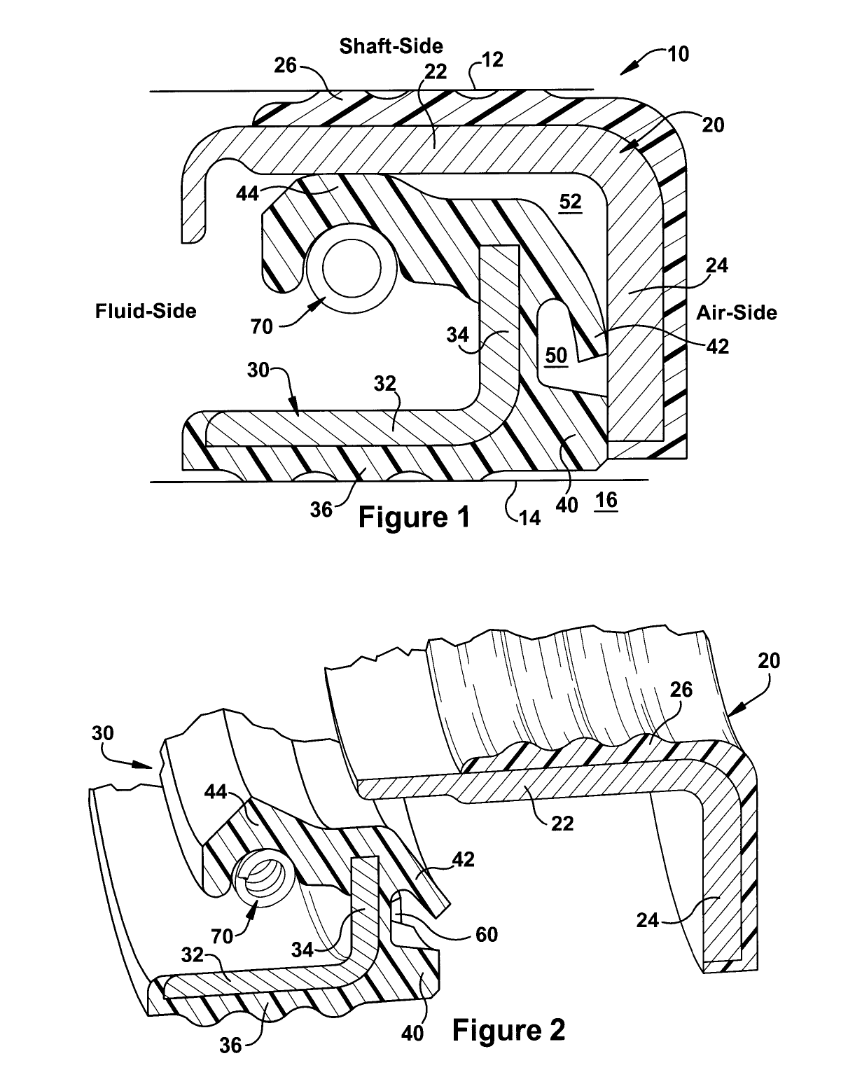

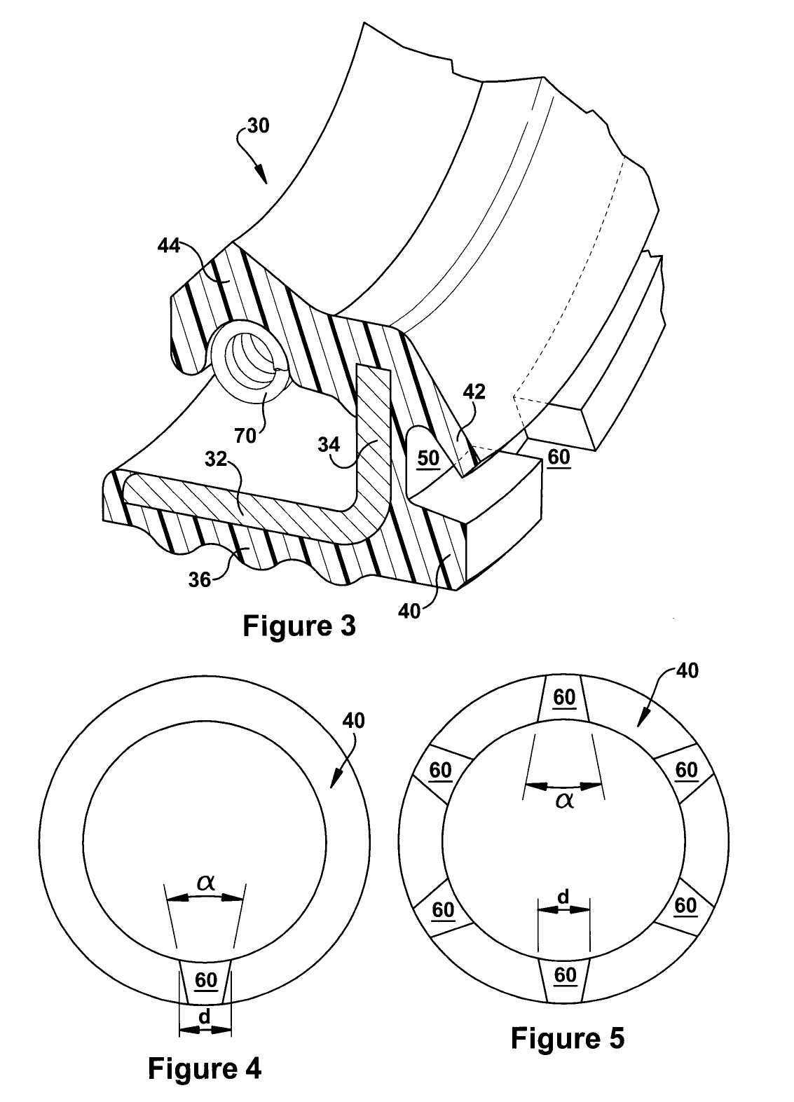

Referring now to the drawings, and initially to FIGS. 1-3, a seal 10 is shown. The seal 10 seals the annular interface between a shaft 12 and a bore-defining wall 14 of a surrounding part 16, which rotate relative to each other. For example, the shaft 14 can rotate and the surrounding part 16 (e.g., a housing) can remain stationary, the surrounding part 16 (e.g., a hub) can rotate and the shaft 12 can remain stationary, or both the shaft 14 and the surrounding part 16 can rotate (at the same or different speeds and/or in the same or opposite directions).

The seal 10 comprises a sleeve 20 fixed (e.g., press-fit) to the shaft 12 for movement (or non-movement) therewith. The sleeve 20 comprises an inner axial wall 22 and a radial wall 24 extending outward from the air-side end of the axial wall 22. The sleeve 20 can be made of a rigid material and/or a metal material such as steel (e.g., cold rolled low carbon steel). The air-side and shaft-side surfaces of the sleeve 20 can be provided with a rubber or other coating 26 to facilitate press-fitting over the shaft 12 and/or to compensate for uneven wear on the shaft surface.

The seal 10 comprises a case 30 fixed (e.g., press-fit) to the bore-defining wall 14 of the surrounding part 16 for movement (or non-movement) therewith. The case 30 comprises an outer axial wall 32 and a radial wall 34 extending inward from the air-side end of the axial wall 32. The case 30 can be made of the same material as the sleeve 20 (e.g., a rigid material and/or metal material). The outer side of the case 30 can be provided with rubber or other coating 36 to facilitate press-fitting within the bore and/or to compensate for irregular wear on the bored-defining wall 14.

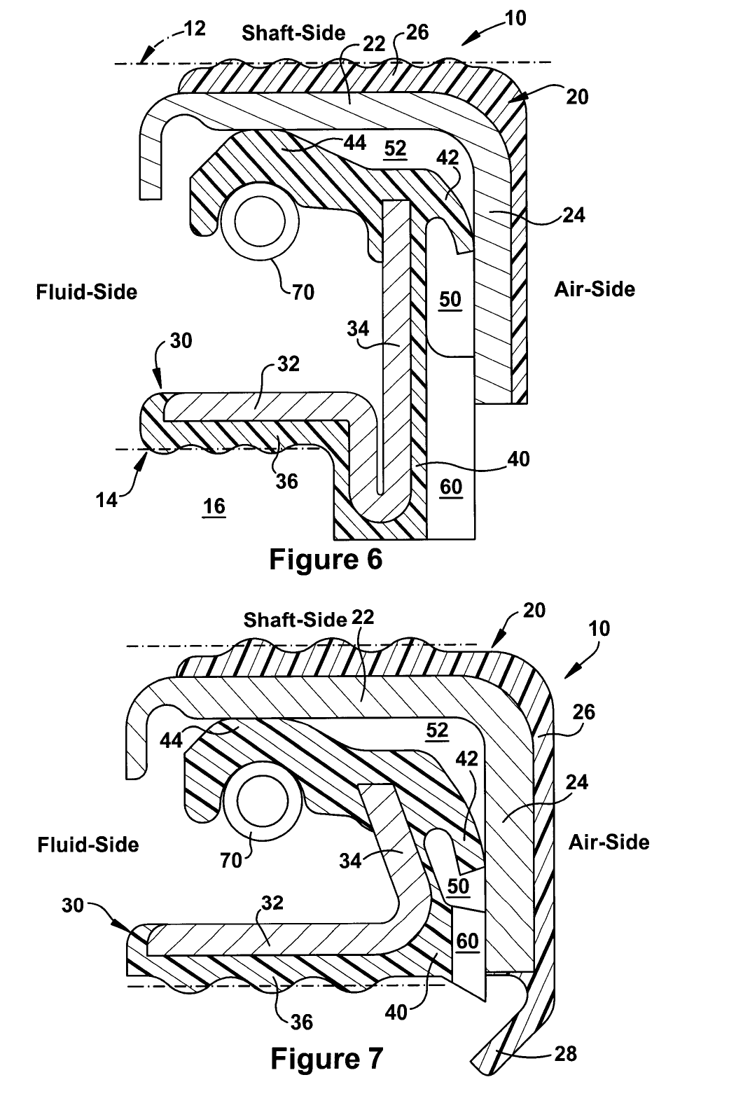

To assemble the seal 10, the case 30 is inserted into the sleeve 20. After such insertion, the fluid-side end of the sleeve's axial wall 22 can be bent outward to prevent separation of the sleeve 20 and the case 30. The air-side end of the sleeve 20 and/or its coating 26 can include an additional lip 28 to provide a preliminary shield against, for example, the penetration of high pressure wash-down spray. (See FIG. 7.) The axial wall 32 and/or the radial wall 34 of the sleeve 30 can remain substantially perpendicular, or one or both walls can bend to accommodate the installation space. (See FIG. 6 and FIG. 7.) If the walls 32/34 are bent (and even if they are not), the case 30 can be constructed to provide a protrusion serving as an installation stop and/or a removal knob. (FIG. 6.) The seal 10 further comprises a bumper lip 40, a dirt lip 42, and a primary lip 44. In the seal 10 shown in FIGS. 1-3, the bumper lip 40, the dirt lip 42, and the primary lip 44 are formed from a seal body bonded to the case 30. But these components need not be formed from the same seal body and/or bonded to the case 30. For example, the bumper lip 40 could be formed from a seal body bonded to the sleeve 20 and the lips 42/44 could be formed from a seal body bonded to the case 30. (See FIG. 9.) In either or any event, the lips 40/42/44, and/or the seal body forming these lips, can be made from an elastomeric material, such as rubber. And the lip-interacting surfaces of the sleeve 20 should be finished in an appropriate fashion.

The bumper lip 40 and the dirt lip 42 form a chamber 50 between the sleeve's radial wall 24 and the case's radial wall 34. The dirt lip 42 and the primary lip 44 form a chamber 52 between them and the sleeve 20. The bumper lip 40 forms the air-side end of the chamber 50, the primary lip 44 forms the oil-side end of the chamber 52, and the dirt lip 42 separates the chamber 50 from the chamber 52.

The bumper lip 40 can serve as a rough barricade for contaminants attempting to encroach the sealed interface. But many contaminants will sneak past the bumper lip 40 into the chamber 50 whereat they are blocked against further ingress by the dirt lip 42. A drain passage 60 extends from this chamber 50 and, in the illustrated embodiment, through the bumper lip 40. A strip of a low friction material (PTFE) can be incorporated into the bumper lip 40 to smooth rotation of the sleeve 12 thereby.

Contaminants in the chamber 50 are directed outward by centrifugal forces generated by the rotating part (e.g., the shaft 12 and/or the surrounding part 16) and drop through the drain passage 60 away from the sealed interface. In this manner, the chamber 50 is continuously drained of contaminants.

Without drainage through the passage 60, the contaminants would accumulate in the chamber 50 and eventually slip by the dirt lip 46 into the chamber 52. In the chamber 52, they would be trapped between the lips 44 and 46. The natural wobble of the rotating shaft 12 would compact these trapped contaminants into a relative hard mass that would eventually lift the primary lip 44 away from the sleeve 20. This lifting would open the oil-side the chamber 52, allowing lubricant to leave through the air-side of the seal 10 and permitting contaminants to penetrate the fluid-side of the seal 10. Because the drain passage 60 circumvents any contaminant ingress past the dirt lip 42, lubrication-loss and contaminant-penetration are prevented.

The drain passage 60 can be positioned to vertically drain the chamber 50 so that gravity can contribute to contaminant removal. With a horizontal shaft 12, the drain passage 60 can be situated at the six-o-clock position. (See FIG. 4.) With non-horizontal shafts and/or non-land applications, a series of drain passages 60 can be provided to drain the chamber 50. These drain passages 60 can be arranged circumferentially around the bumper lip 42. (See FIG. 5.)

The drain passages 60 can each have a dominating entrance cross-sectional dimension d (e.g., diameter, width, etc.) to allow sufficient drainage therefrom. For example, the dimension d can be greater than 1 mm and/or less than 20 mm. In a multi-drain seal, the number of passages may influence individual passage dimensions. The passages 60 can have a constant cross-section or they can have an angle a of converge/diverge between entrance-exit.

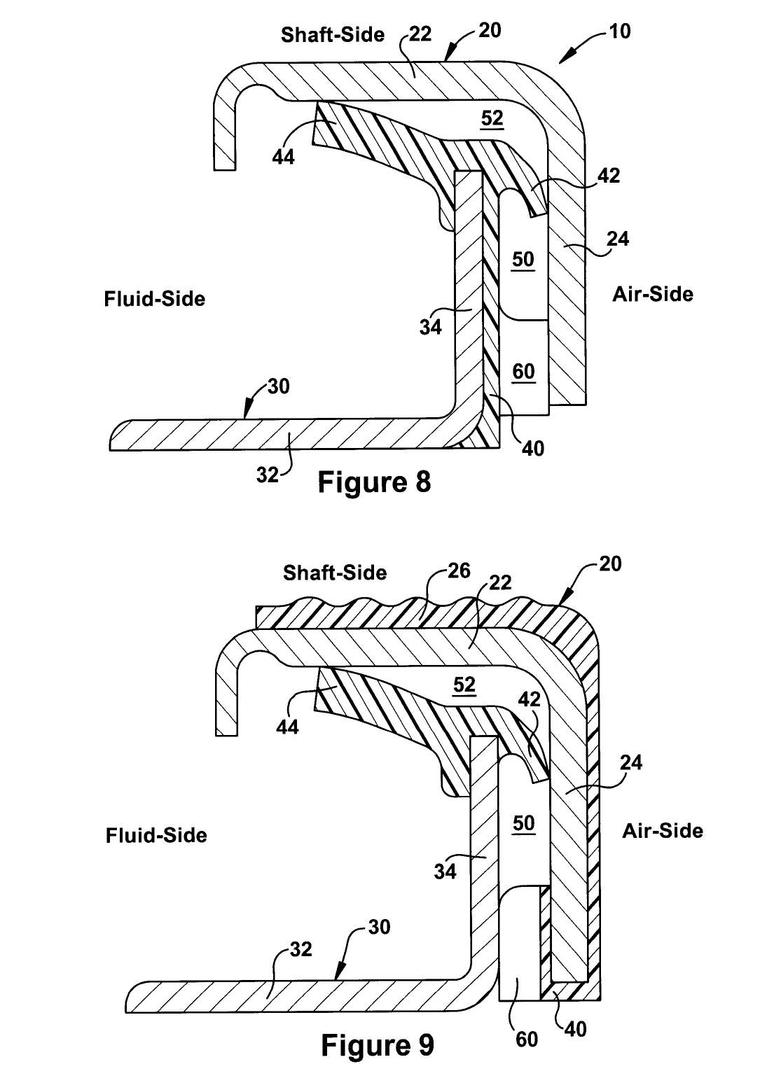

The seal 10 can also include a spring 70 for sealing lighter fluids such as mineral oil. The spring 70 is positioned inward of the primary lip 44 to bias it outward towards the sleeve 20. If more viscous fluids are used (e.g., grease), the spring 70 can be eliminated. (See FIGS. 8 and 9.)

Although the seal 10 has been shown and described with respect to a certain embodiment or embodiments, it is obvious that equivalent alterations and modifications will occur to others skilled in the art upon the reading and understanding of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application.

1. A seal for sealing the interface between a shaft and a bore-defining wall of a surrounding part, the seal comprising;
a sleeve having an inner axial wall and a radial wall extending outward from an air-side end of the axial wall;
a case having an outer axial wall and a radial wall extending inward from an air-side end of the axial wall;
a chamber between the sleeve's radial wall and the case's radial wall;
a dirt lip defining the fluid-side end of the chamber; and
a drain passage extending from the chamber to the air-side of the seal.

2. A seal as set forth in claim 1, further comprising a bumper lip defining the air-side end of the chamber and wherein the drain passage passes through the bumper lip.

3. A seal as set forth in claim 2, wherein the drain passage is situated to vertically drain the chamber.

4. A seal as set forth in claim 1, wherein the drain passage is situated to vertically drain the chamber

5. A seal as set forth in claim 1, comprising a plurality of drain passages extending from the chamber to the air-side of the seal.

6. A seal as set forth in claim 5, wherein each drain passage passes through the bumper lip.

7. A seal as set forth in claim 6, wherein the drain passages are circumferentially spaced around the bumper lip

8. A seal as set forth in claim 2, wherein the bumper lip and the dirt lip are formed from a seal body bonded to the case.

9. A seal as set forth in claim 2, wherein the bumper lip is formed from a seal body bonded to the sleeve and the dirt lip is formed from a seal body bonded to the case.

10. A seal as set forth in claim 2, further comprising a chamber between the sleeve's axial wall and the case's axial wall and a primary lip defining the oil-side of this chamber.

11. A seal as set forth in claim 10, further comprises a spring urging the primary lip towards the sleeve's axial wall.

12. A seal as set forth in claim 10, wherein the primary lip is formed from a seal body bonded to the case.

13. A seal as set forth in claim 10, wherein the primary lip and the dirt lip are formed from a seal body bonded to the case.

14. A seal as set forth in claim 13, wherein the bumper lip is formed from a seal body bonded to the sleeve.

15. A seal as set forth in claim 10, wherein the primary lip, the dirt lip, and the bumper lip are formed from a seal body bonded to the case.

16. A rotating assembly comprising:
a shaft;
a surrounding part having a wall defining a bore in which the shaft is positioned, the shaft and the surrounding part rotating relative to each other;
the seal of claim 1 sealing the interface between the shaft and the bore-defining wall wherein the sleeve is fixed to the shaft for movement-nonmovement therewith and the case is fixed to the bore-defining wall for movement-nonmovement therewith.

17. A rotating assembly as set forth in claim 16, wherein the shaft rotates and the surrounding part remains stationary.

18. A rotating assembly as set forth in claim 16, wherein the surrounding part rotates and the shaft remains stationary.
